(19) United States
(12) Patent Application Publication
(10) Pub. No.: US 2026/0072594 A1
(43) Pub. Date: Mar. 12, 2026

(54) CANCELLING UNUSED READ COMMANDS FOR ACCESSING DATA IN MEMORY

(71) Applicant: International Business Machines Corporation, Armonk, NY (US)

(72) Inventors: Glenn David GILDA, Binghamton, NY (US); David D. CADIGAN, Danbury, CT (US); Stephen J. POWELL, Austin, TX (US); Logan Ian FRIEDMAN, Nyack, NY (US); Brooke ALBANESE, Endicott, NY (US); Mark Ronald HODGES, Endicott, NY (US); Nicholas Steven ROLFE, Hyde Park, NY (US); Patrick James MEANEY, Poughkeepsie, NY (US)

(21) Appl. No.: 18/829,278

(22) Filed: Sep. 9, 2024

(51) Int. Cl. G06F 3/06

(52) U.S. Cl. CPC G06F 3/0613; G06F 3/0659; G06F 3/0673

(57) ABSTRACT

In some implementations, a controller may determine that a read response, to a read command of a plurality of read commands, has not been received from a memory device of a plurality of memory devices. The controller may provide a cancel command to the memory device to cause the memory device to cancel the read command based on determining that the read response, to the read command, has not been received from the memory device, wherein the cancel command is provided after read responses, to other read commands of the plurality of read commands, have been received from other memory devices of the plurality of memory devices, and wherein the cancel command includes an identifier associated with the read command.

### BACKGROUND

The present invention relates to read commands, and for example, relates to cancelling read commands. A read command (also referred to as “fetch” or “fetch command”) may be issued to perform a read operation at a location in memory. For example, the read command may be issued (e.g., by a host device) to read (or access) data stored in the location in the memory. The read command may cause congestion with respect to the memory (e.g., in the form of a busy dynamic random-access memory (DRAM) bank when the data is being accessed), may cause throughput/bandwidth overhead (e.g., when the data is being accessed), and may consume a considerable of amount of power when the read command is forwarded to the memory (e.g., forward to a memory buffer chip).

In some situations, read commands may be issued speculatively in anticipation of future parallel read operations to read locations in the memory. Additionally, the read commands may be issued speculatively to reduce latency associated with accessing the locations in the memory. Because the read commands are issued speculatively, the read commands (or data accessed as a result of the read commands) may be unused. In the event the read commands are unused, the read commands may cause multiple technical problems. For example, in the event the read commands are unused, the read commands may cause unnecessary congestion with respect to the memory (e.g., in the form of busy dynamic random-access memory (DRAM) banks), unnecessary throughput/bandwidth overhead, and unnecessary consumption of power when the read commands are forwarded to the memory (e.g., forward to a memory buffer chip).

A staggered memory refresh system may be an example of a system that is subjected to the technical problems discussed above in connection with unused read commands. In the staggered memory refresh system, a host device may be connected to multiple dual in-line memory modules (DIMMs) (also referred to as memory DIMMs) via multiple memory channels (or simply channels). Each DIMM may include one or more DRAMs devices and, in some instances, a memory buffer chip. In some situations, a DIMM may undergo a memory refresh. The “memory refresh” may refer to an operation that prevents data, stored in the DIMM, from being degraded or from being lost. In the staggered memory refresh system, each DIMM may undergo a memory refresh at different times. Furthermore, a staggered memory refresh system may incorporate redundant array of independent memory (RAIM) error correction code (ECC). RAIM ECC allows for recovery of data if a memory channel fails to respond or is delayed in responding. RAIM ECC can be used in a staggered memory refresh system to improve system performance by forwarding data from N−1 memory channels if an Nth memory channel is delayed due to refresh. RAIM ECC reconstructs the data missing from the Nth memory channel. In this manner, the performance effects of memory refresh operations can be substantially hidden.

In some situations, the host device may issue a read command that is forwarded via the multiple channels to the multiple DIMMs. Because a particular DIMM may be undergoing a memory refresh, the host device may not receive data from the particular DIMM but may receive remaining data from remaining DIMMs. As described above, the remaining data may be processed by RAIM and the processed remaining data may be provided to the host device. As result, the data from the particular DIMM may be unused. However, after the memory refresh is completed, the data may be obtained from a DRAM of the particular DIMM.

Obtaining the data, when the data is unused, may cause the technical problems discussed herein. Accordingly, there is a need to address unused read commands after the read commands have reached the memory buffer chip.

### SUMMARY

In some implementations, a system comprising: a plurality of memory devices; and a memory controller, in communication with the plurality of memory devices, to: provide a plurality of read commands to the plurality of memory devices; determine that a read response, to a read command of the plurality of read commands, has not been received from a memory device of the plurality of memory devices; and provide a cancel command to the memory device to cause the memory device to cancel the read command based on determining that the read response, to the read command, has not been received from the memory device, wherein the cancel command includes an identifier associated with the read command, and wherein the memory device identifies the read command using the identifier.

The plurality of memory devices may be dual in-line memory modules (DIMMs). An advantage of the cancel command is to cancel the read command prior to the read command being processed by the memory device. Accordingly, an advantage of the cancel command is preventing congestion that would have been caused on the memory device as a result of accessing data that is unused by the host computing device. Additionally, an advantage of the cancel command is preserving bandwidth that would have been used to access the data and to provide the data to the host computing device. Additionally, an advantage of the new cancel command is preserving power that would have been consumed to access the data and to provide the data to the host computing device.

Additionally, the controller may receive information indicating that the read command has been cancelled. In other words, the controller may receive a response (also referred to as cancel command response) to the cancel command. Accordingly, an advantage of the cancel command and the cancel command response is preserving bandwidth that would have been used to provide the data to the host computing device.

In some implementations, a computer-implemented method includes determining, by a controller, that a read response, to a read command of a plurality of read commands, has not been received from a memory device of a plurality of memory devices; and providing, by the controller, a cancel command to the memory device to cause the memory device to cancel the read command based on determining that the read response, to the read command, has not been received from the memory device, wherein the cancel command is provided after read responses, to other read commands of the plurality of read commands, have been received from other memory devices of the plurality memory devices, and wherein the cancel command includes an identifier associated with the read command.

The plurality of memory devices may be dual in-line memory modules (DIMMs). An advantage of the cancel command is to cancel the read command prior to the read command being processed by the memory device. Accordingly, an advantage of the cancel command is preventing congestion that would have been caused on the memory device as a result of accessing data that is unused by the host computing device. Additionally, an advantage of the cancel command is preserving bandwidth that would have been used to access the data and to provide the data to the host computing device. Additionally, an advantage of the new cancel command is preserving power that would have been consumed to access the data and to provide the data to the host computing device.

Additionally, the controller may receive information indicating that the read command has been cancelled. In other words, the controller may receive a response (also referred to as cancel command response) to the cancel command. Accordingly, an advantage of the cancel command and the cancel command response is preserving bandwidth that would have been used to provide the data to the host computing device.

In some implementations, a computer program product comprising: one or more computer readable storage media, and program instructions collectively stored on the one or more computer readable storage media, the program instructions comprising: program instructions to determine that a read response, to a read command of a plurality of read commands, has not been received from a memory device of a plurality of memory devices; and program instructions to provide a cancel command to the memory device to cause the memory device to cancel the read command based on determining that the read response, to the read command, has not been received from the memory device, wherein the cancel command is provided after read responses, to other read commands of the plurality of read commands, have been received from other memory devices of the plurality memory devices.

The plurality of memory devices may be dual in-line memory modules (DIMMs). An advantage of the cancel command is to cancel the read command prior to the read command being processed by the memory device. Accordingly, an advantage of the cancel command is preventing congestion that would have been caused on the memory device as a result of accessing data that is unused by the host computing device. Additionally, an advantage of the cancel command is preserving bandwidth that would have been used to access the data and to provide the data to the host computing device. Additionally, an advantage of the new cancel command is preserving power that would have been consumed to access the data and to provide the data to the host computing device.

Additionally, the controller may receive information indicating that the read command has been cancelled. In other words, the controller may receive a response (also referred to as cancel command response) to the cancel command. Accordingly, an advantage of the cancel command and the cancel command response is preserving bandwidth that would have been used to provide the data to the host computing device.

### BRIEF DESCRIPTION OF THE DRAWINGS

FIG. 1 is a diagram of an example system described herein.

FIG. 2A-2I is a diagram of an example implementation of cancelling read commands described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with cancelling read commands.

### DETAILED DESCRIPTION

The following detailed description of example implementations refers to the accompanying drawings. The same reference numbers in different drawings may identify the same or similar elements.

Host could cancel unneeded request to Nth channel once successful read data returned to reduce overhead, but there is no means to do so in the prior art once command is in memory buffer chip on a memory DIMM.

Implementations described herein are directed to removing unnecessary read commands in a memory buffer chip of a system, thereby preserving available bandwidth and power in the system. The system may include a host computing device that includes a memory controller, a plurality of memory channels (also referred to as channels), and a plurality of memory DIMMS connected to the host device via the channels. A memory DIMM may include one or more ranks of DRAMs. A rank of DRAMs may include one or more DRAMs and a memory DIMM may include a memory buffer chip.

Implementations described herein are directed to cancelling read operations (also referred to as fetch operations) that are already scheduled in a memory buffer chip (of the system) using a new cancel command. The read operations may be associated with unused read commands. An “unused read command” may refer to a read command, issued by the host computing device, that results in accessing (or obtaining) data that is not used by the host computing device (also referred to “unused data”). The unused read command may be issued speculatively in anticipation of future parallel read operations to read locations in the memory and issued speculatively to reduce latency associated with accessing memory. The unused data may be provided via a particular channel to a memory controller after other data has been provided to the host computing device via other channels.

In this regard, the unused read command on an Nth channel (a last channel to respond) may be canceled using the new cancel command after the memory controller has received data from N−1 channels as responses to a read command (also referred to as a fetch command). The new cancel command may be provided from the host computing device to a memory buffer chip to cancel (or remove) a pending read operation (associated with the read command) in the memory buffer. The new cancel command may include information identifying the read command.

In some implementations, the new cancel command may be a new command under Open Coherent Accelerator Processor Interface (OpenCAPI). For example, the new cancel command may include an out-of-spec command and a template supporting OpenCAPI Memory Interface (OMI). For instance, the new cancel command may be included in a template of OpenCAPI transaction layer. The new cancel command may include a Coherent Accelerator Processor Proxy (CAPP) Tag (CAPPTag) identifier that identifies the pending read operation to be canceled. Each pending read operation has a unique CAPPTag identifier that was also included with the operation when it was sent. In some examples, the cancel command may be included in a template that may include up to three cancel commands. While implementations herein are described with respect to OpenCAPI and OMI, implementations described herein may apply to Compute Express Link (CXL) technology.

The new cancel command may cancel an unused read command. Accordingly, an advantage of the new cancel command is preventing congestion that would have been caused on a DIMM as a result of accessing data that is unused by the host computing device. Additionally, an advantage of the new cancel command is preserving bandwidth that would have been used to access the unused data and to provide the unused data to the host computing device. Additionally, an advantage of the new cancel command is preserving power that would have been consumed to access the unused data and to provide the unused data to the host computing device.

Implementations described herein are directed to a new cancel command response to the new cancel command. The new cancel command response may be provided from the memory buffer chip back to the host computing device to indicate that the read command has been successfully canceled and that data will not be returned. In some examples, the new cancel command response may be a new command response under OpenCAPI. For example, the new cancel command response may be an out-of-spec response to the host computing device indicating that the read command has been successfully cancelled. The new cancel command response may be included in a template of OpenCAPI.

The new cancel command may initiate the new cancel command response that reports that no data will be returned from the DIMM for a read operation. Accordingly, an advantage of the new cancel command and the new cancel command response is preserving bandwidth that would have been used to provide the unused data to the host computing device.

In some examples, the system may include a redundant array of independent memory (RAIM) system. Implementations described herein may be applied to other non-RAIM systems with multiple memory channels for redundancy, e.g. memory mirroring where N=2. Implementations described herein may enable use of staggered refresh by sending commands to both DIMMs.

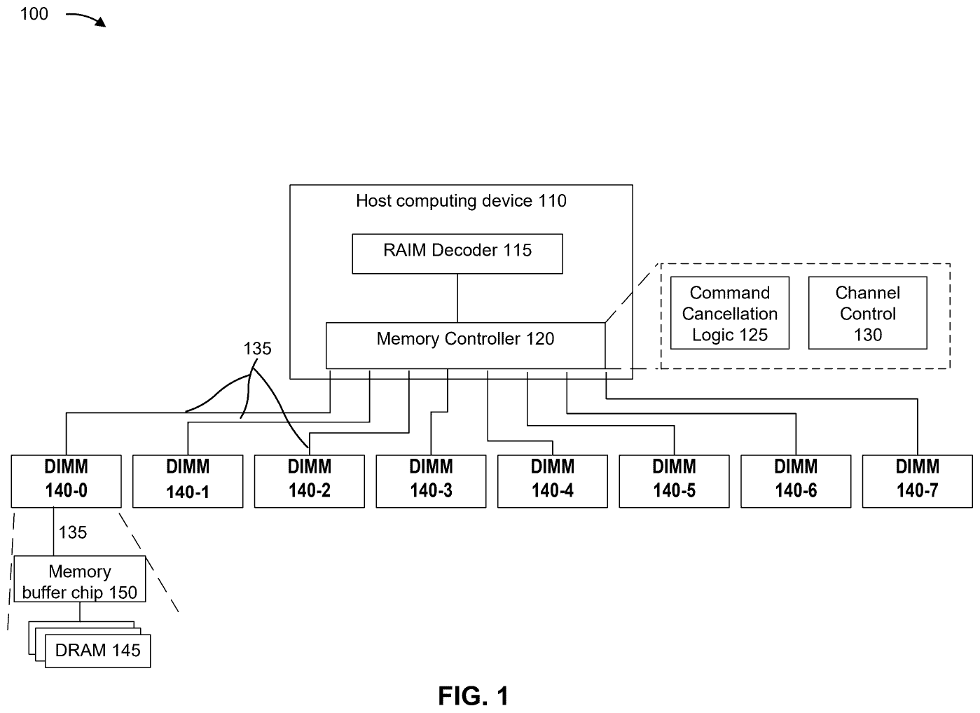

FIG. 1 is a diagram of an example system 100 described herein. As shown in FIG. 1, implementation 100 may include a host computing device 110, multiple channels 135 (also called memory channels 135), and multiple memory DIMMs (also referred to as DIMMs) connected to host computing device 110 via channels 135. The memory DIMMS may include memory DIMM 140-0, memory DIMM 140-1, and so on (collectively memory DIMMs 140). As shown in FIG. 1, host computing device 110 may be connected to memory DIMMs 140 via channels 135 (individually “memory channel 135”). While FIG. 1 illustrates system 100 as including 8 channels 135 connected to 8 memory DIMMs 140, in some examples system 100 may include more channels 135 and more memory DIMMs 140 or less channels 135 and less memory DIMMs 140. A memory DIMM 140 may include a memory device.

Host computing device 110 may include one or more devices configured to receive, generate, store, process, and/or provide information associated with cancelling unused read commands, as explained herein. Host computing device 110 may include a communication device and a computing device. For example, host computing device 110 may include a wireless communication device, a control processor system, a mobile phone, a user equipment, a laptop computer, a tablet computer, a desktop computer, and/or a similar type of device.

Host computing device 110 may issue different commands to cause different operations to be performed on memory DIMMs 140. For example, host computing device 110 may issue a read command to cause a read operation to be performed on memory DIMMs 140, a write command to cause a write operation to be performed on memory DIMMs 140, and so on. In some situations, the read command may be issued to obtain requested data. If a portion of the requested data is received via a portion of channels 135 (from a portion of DIMMS 140), host computing device 110 may reconstruct the requested data using the portion of the requested data. For example, one or more components of host computing device 110 may reconstruct the requested data, to obtain full requested data, using the portion of the requested data.

As shown in FIG. 1, host computing device 110 may include a RAIM decoder 115. In this regard, system 100 may be configured as a redundant array of independent memory (RAIM) system to support recovery from failures of either DRAM devices or an entire channel. The RAIM system may include memory controller 120 and DIMMs 140. For example, system 100 may be an 8-channel RAIM with differential DIMMs. RAIM decoder 115 may perform error correction operations on data received from DIMMS 140. Data and ECC bytes stored in memory provide for error correction and the ability to tolerate both DRAM and memory channel failures. RAIM decoder 115 may take input data and ECC and may correct or reconstruct any missing data partly based on chip or channel marks provided to RAIM decoder 115.

As shown in FIG. 1, host computing device 110 may also include a memory controller 120. Memory controller 120 may be configured to provide different commands to cause different operations to be performed on memory DIMMs 140. For example, memory controller 120 may provide a read command to cause a read operation to be performed on memory DIMMs 140, may provide a write command to cause a write operation to be performed on memory DIMMs 140, and so on. Memory controller 120 may provide data from memory DIMMs 140 to host computing device 110.

In some implementations, memory controller 120 may issue cancel commands to DIMMS 140, as described herein. In this regard, as shown in FIG. 1, memory controller 120 include command cancellation logic 125. Memory controller 120 may be detect that a response, to a read command, has not been received from a memory DIMM 140 via a channel 135 and may issue a cancel command, to the memory DIMM 140 via the channel 135, to cancel the read command, as described herein. In some implementations, memory controller 120 may monitor identifiers associated with read commands. In some examples, memory controller 120 may use the identifiers to monitor outstanding memory operations.

As show in FIG. 1, memory controller 120 may include a channel control 130. Channel control 130 may monitor memory DIMMs 140 for data returned from memory DIMMs 140. In some implementations, channel control 130 may determine which channels 135 have delivered data for a given operation (e.g., for a given read operation as a result of a given read command).

As shown in FIG. 1, a memory DIMM 140 may include a rank of DRAMs 145 (also referred to as a bank of DRAMs 145). In some situations, a DRAM 145 may be associated with a memory buffer chip 150. For example, the DIMM 140-0 may include a memory buffer chip 150. Memory buffer chip 150 may connect to a channel 135 to receive commands from memory controller 120 and to send responses. DRAM 145 may be connected to a memory buffer chip 150 to receive memory read and write commands and to provide read data

As indicated above, FIG. 1 is provided as an example. Other examples may differ from what is described with regard to FIG. 1. As an example, instead of memory buffer chip 150 and DRAMs 145 being in separate DIMMs 140, memory buffer chips and DRAMs associated with each memory channel could be directly soldered onto a system planar that also contains host computing device 110. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

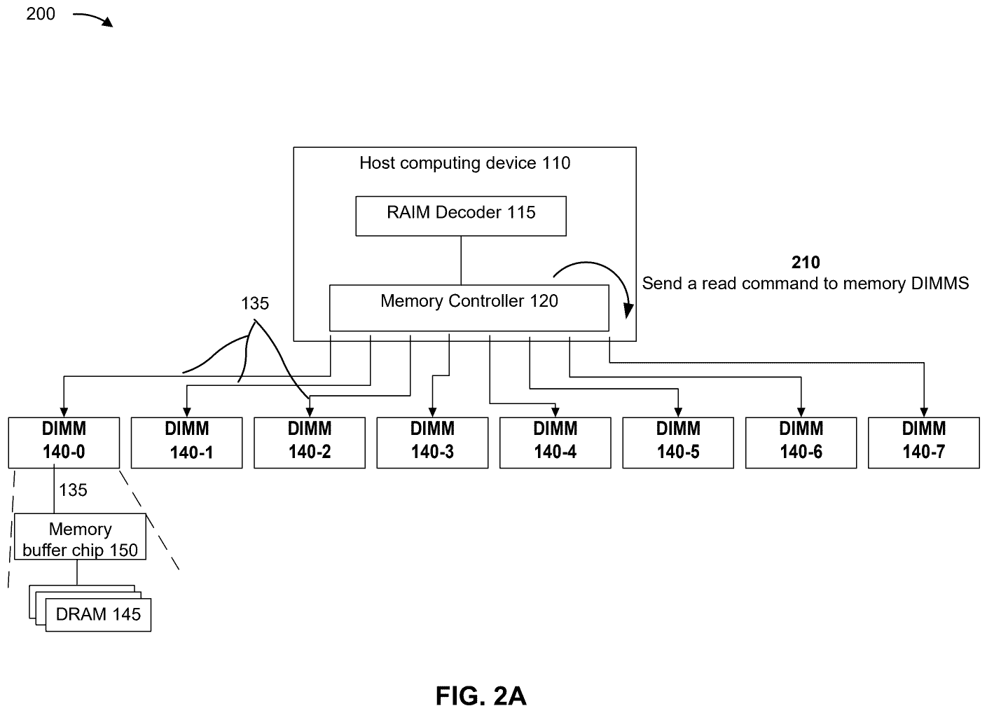

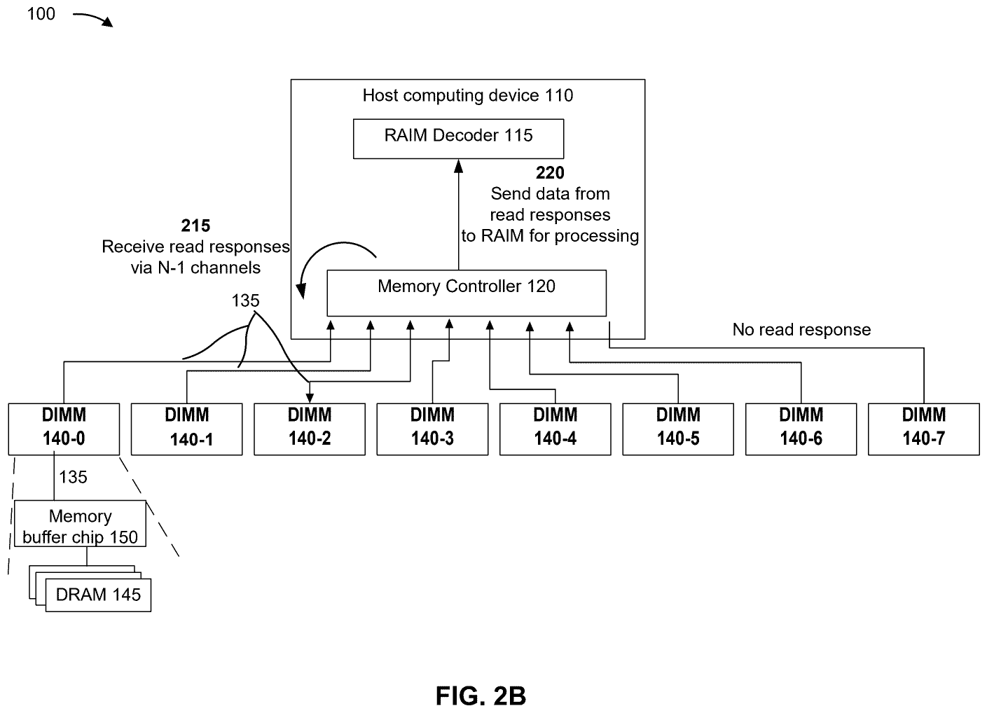

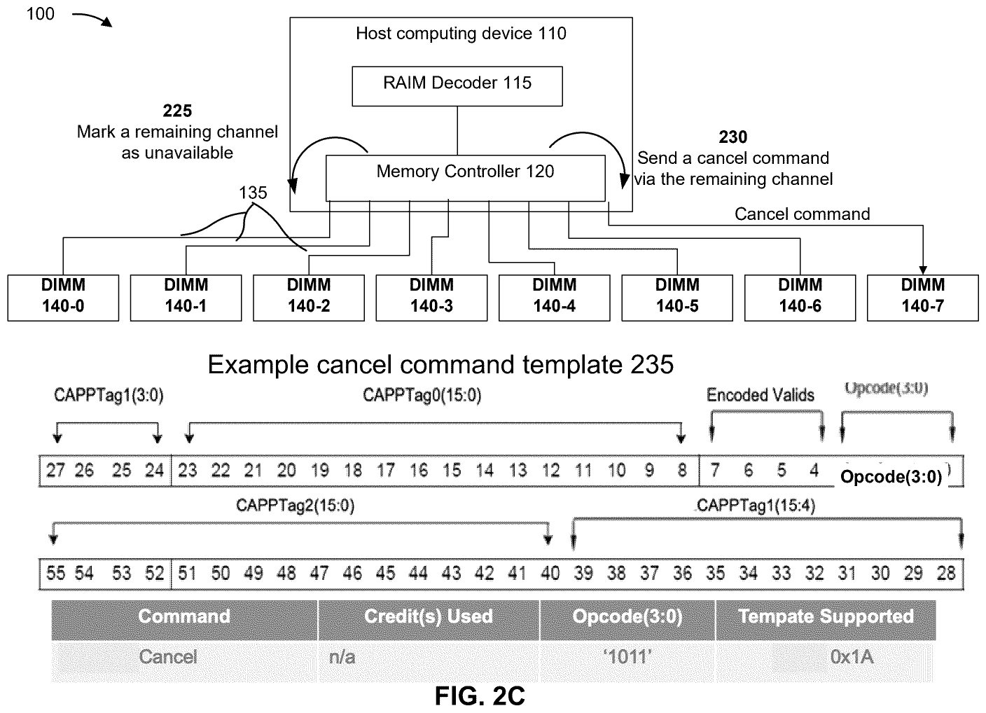

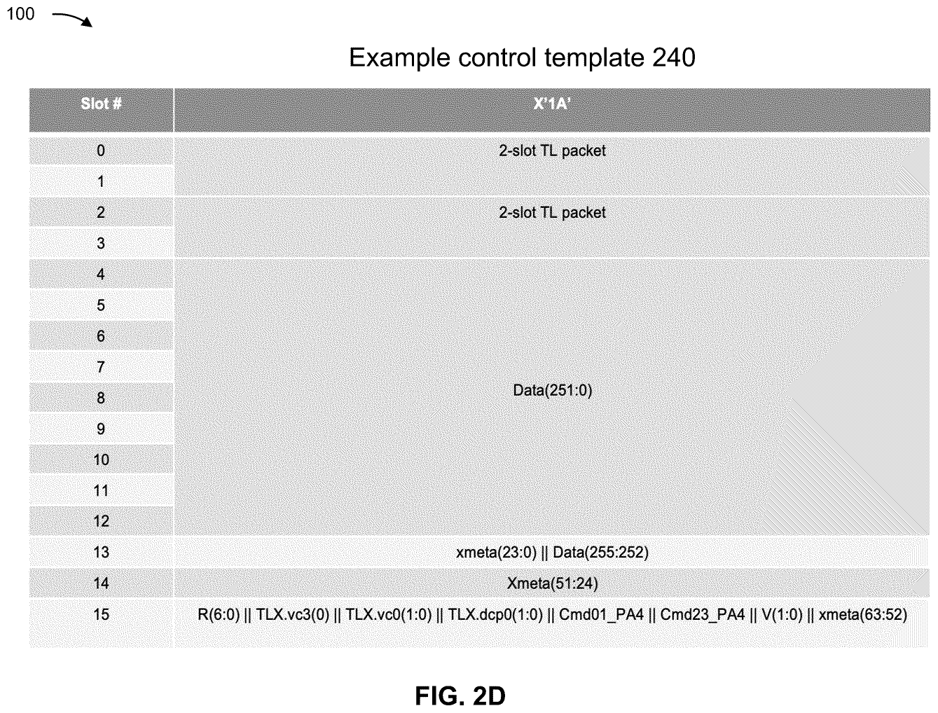

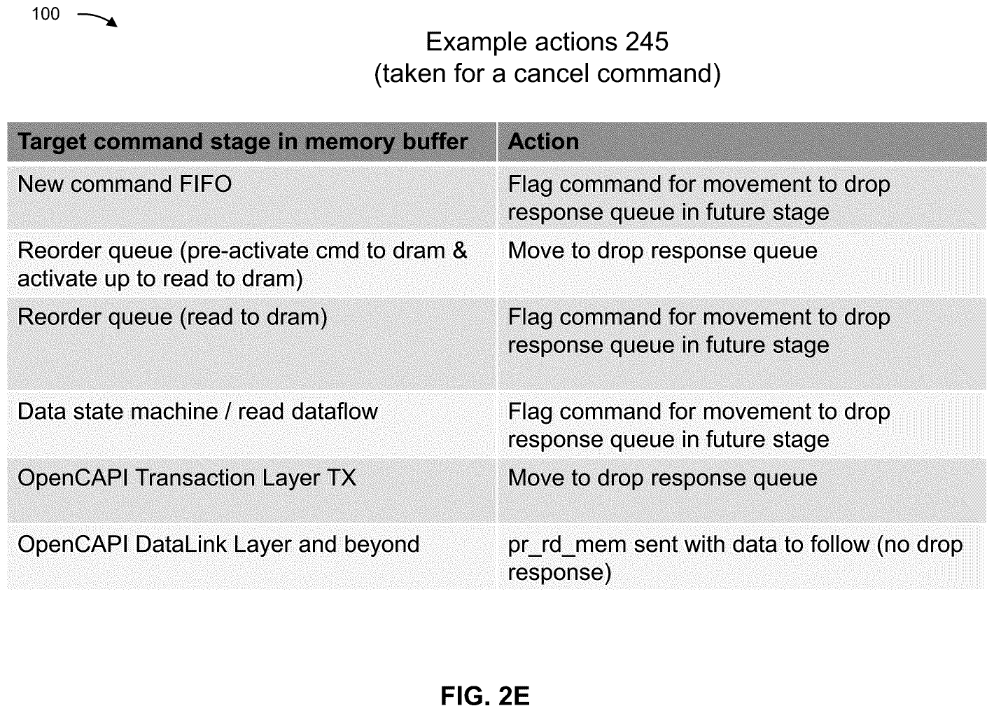

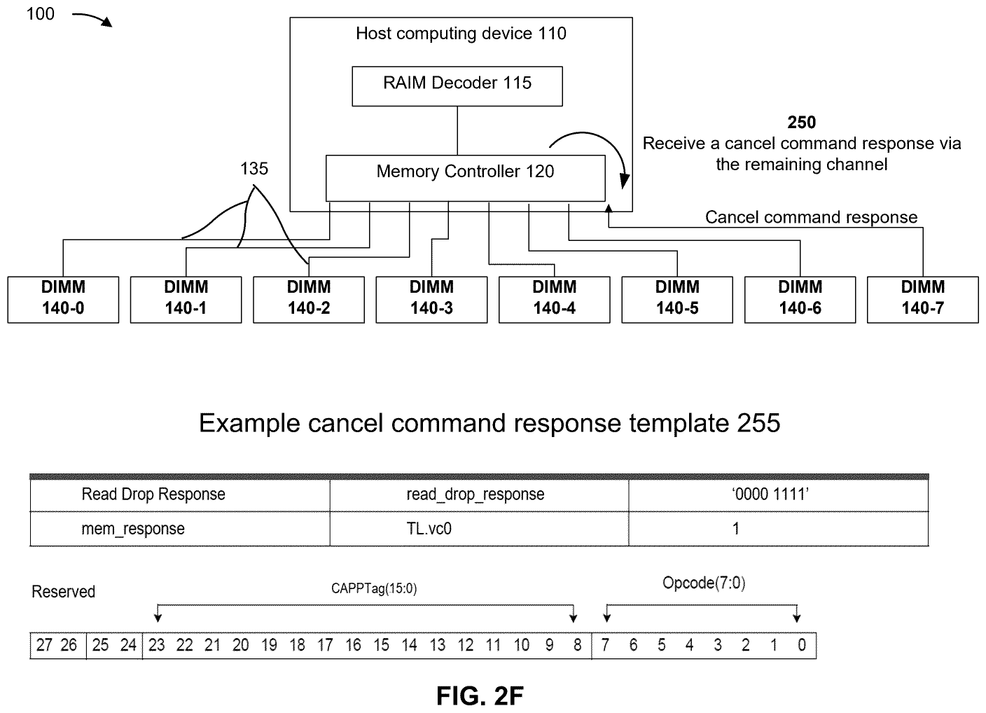

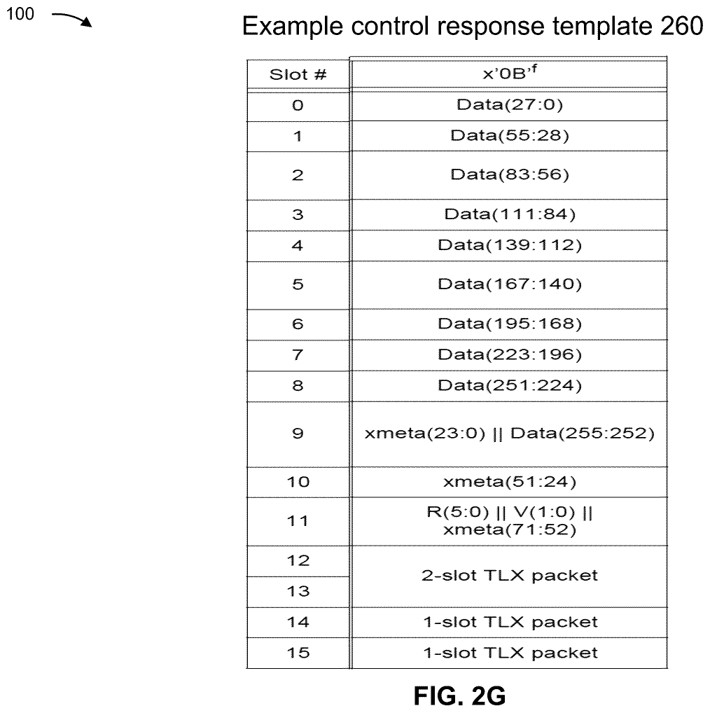

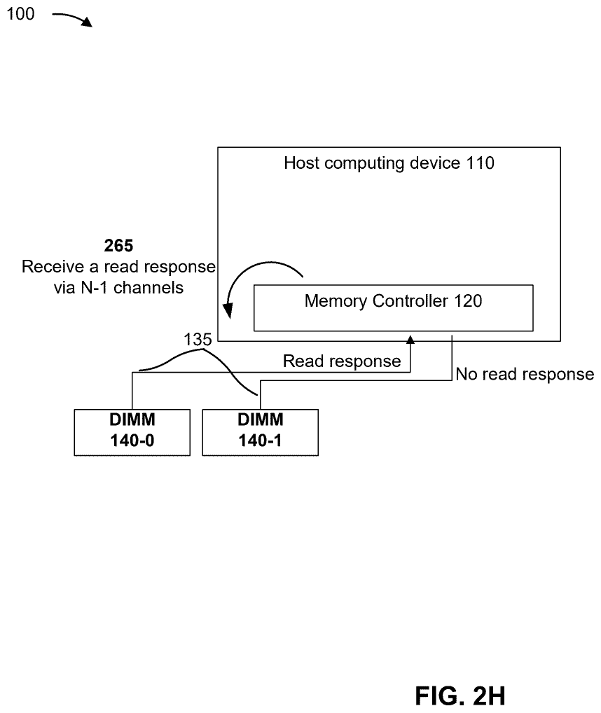

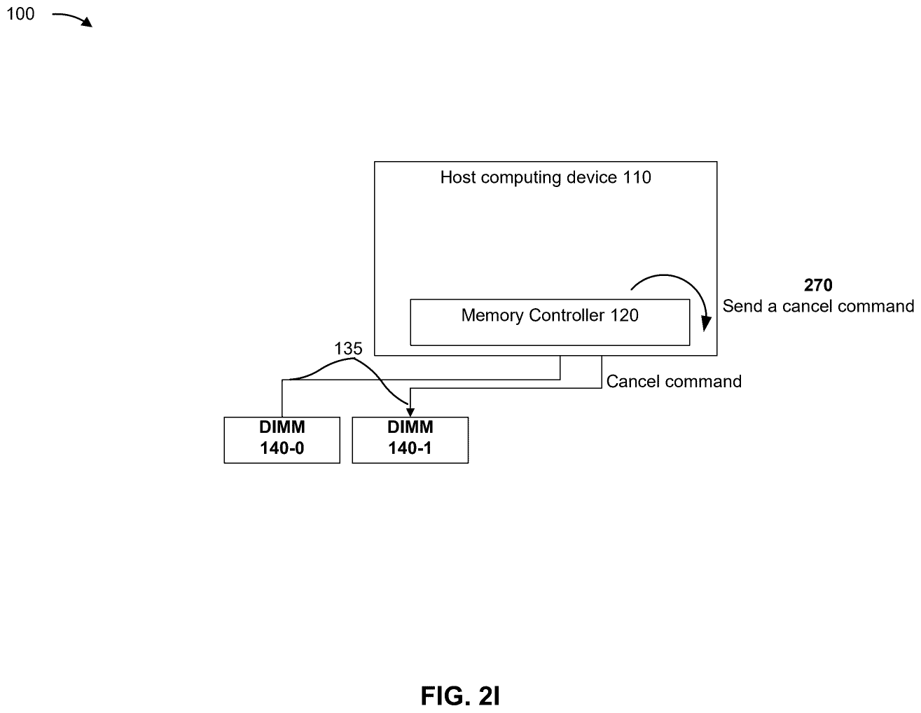

FIGS. 2A-2I are diagrams of an example implementation 200 described herein. As shown in FIGS. 2A-2I, example implementation 200 includes system 100. For example, system 100 may include N channels and corresponding N memory DIMMS 140. In some implementations, N may be 8.

As shown in FIG. 2A, and by reference number 210, memory controller 120 may send a read command to memory DIMMS. For example, host computing device 110 may issue the read command to access data stored in memory DIMMs 140. In some examples, host computing device 110 may issue the read command speculatively in anticipation of future parallel read operations and/or may issue the read command speculatively to reduce latency. In some examples, memory controller 120 may provide the read command to memory DIMMs 140 via channels 135 (e.g., via all channels 135) as shown by the arrows directed to DIMMs 140.

As shown in FIG. 2B, and by reference number 215, memory controller 120 may receive read responses via N−1 channels. For example, based on sending the read command, host computing device 110 may receive the read responses from a portion of memory DIMMs 140 via N−1 channels 135 (e.g., one less channel 135 than all channels 135). In other words, host computing device 110 may receive the read responses from less than all memory DIMMs 140 (e.g., one less memory DIMM 140 than all memory DIMMS 140) as shown by the arrows directed to memory controller 120.

In some embodiments, a read response may include data obtained from a memory DIMM 140 (e.g., obtained from one or more ranks of DRAMs). Additionally, the read response may include information (e.g., an identifier) identifying a read command that requested the data from memory. In some implementations, the read response may be included in a template of OpenCAPI. In this regard, the identifier may include a CAPPTag identifier.

As shown in FIG. 2B, and by reference number 220, memory controller 120 may send data from read responses to RAIM for processing. In some implementations, memory controller 120 may determine that the read responses have been received via a number threshold of channels 135. In some examples, the number threshold may be N−1. In some examples, the number threshold may be a number different than N−1. For example, the number threshold may be N−2, N−3, and so on.

In some examples, channel control 130 may identify from which channel 135 and which DIMM 140 a read response is originating based on a channel 135 that the response is received from. Based on determining that the read responses have been received via the number threshold of channels 135, memory controller 120 may determine that a sufficient amount of data has been obtained for host computing device 110. Accordingly, memory controller 120 may send the data to RAIM decoder 115 for processing, prior to the data being sent to host computing device 110. RAIM decoder 115 may perform an error correction operation on the data. After the error correction has been performed, the data may be provided to one or more components of host computing device 110.

As shown in FIG. 2C, and by reference number 225, memory controller 120 may mark an unavailable channel as unavailable. For example, memory controller 120 (e.g., channel control 130) may determine that a read response has not been received from an unavailable channel 135 (e.g., of the N channels). Based on determining that the read response has not been received from the unavailable channel 135 and a number threshold of channels 135 have provided a read response corresponding to a previously sent read command, memory controller 120 may determine that the unavailable channel 135 is unavailable. Accordingly, memory controller 120 may mark the unavailable channel 135 as unavailable. The memory controller 120 may then send the data to RAIM decoder 115 along with the mark indicating which channel is not providing data so that RAIM can perform error correction to recover the data not provided. Additionally, memory controller 120 may generate information indicating that a read response received from the unavailable channel 135 is to be ignored. This mark only applies to the data being sent to RAIM decoder 115 for the read command that originally requested the data. Subsequent read commands may encounter delayed read responses on a different channel, which would result in a different mark being sent with the data to RAIM decoder 115 for those read commands.

As shown in FIG. 2C, and by reference number 230, memory controller 120 may send a cancel command via the unavailable channel. For example, after sending the data (received via the number threshold of channels 135) to RAIM decoder 115, memory controller 120 may determine that the read response has not been received from the unavailable channel 135. Based on determining that the data has been sent to RAIM decoder 115 and determining the read response has not been received from the unavailable channel 135 after the data has been sent to RAIM decoder 115, memory controller 120 may generate and send a cancel command via the unavailable channel 135 (e.g., as shown in the arrow directed to the unavailable channel 135).

The cancel command may remove the read command from a memory DIMM 140 (or, in other words, to cancel the read command in the memory DIMM 140).

As shown in FIG. 2C, the unavailable channel 135 may be connected to memory DIMM 140-7. In this regard, memory controller 120 may determine that data has not been received from memory DIMM 140-7 via the unavailable channel. Accordingly, memory controller 120 may send the cancel command to memory DIMM 140-7. In some examples, memory controller 120 may send the cancel command to a memory buffer chip 150 associated with a DRAM 145. In some implementations, the cancel command may include information identifying the read command to enable DIMM 140-7 and/or the memory buffer chip 150 (associated with the DRAM 145) to identify the read command to be cancelled.

In some implementations, the cancel command may be included in a template of OpenCAPI (e.g., a template of OpenCAPI transaction layer). In this regard, the information identifying the cancel command may include a CAPPTag identifier. The cancel command may be a new command and template not part of the OpenCAPI transaction layer specification version 3.1.

For example, as shown in FIG. 2C, an example cancel command 235 may be used to cancel the read command. As shown in FIG. 2C, cancel command 235 may include an opcode 1011 that defines a cancel command opcode. As shown in FIG. 2C, an encoded valids may enable cancel command 235 to include multiple cancel commands. For example, the encoded valids may enable cancel command 235 to include up to three cancel commands (e.g., template supporter 0x1A). In this regard, and as shown in FIG. 2C, cancel command 235 may include multiple CAPPTag identifiers that identify multiple cancel commands.

As shown in FIG. 2D, an example control template 240 that may be used to send the cancel command. As shown in FIG. 2D, control template 240 may provide a control flit format on a transaction layer of OpenCAPI Memory Interface, as defined by OpenCAPI Transaction Layer Specification 3.1. A flit may include an acronym for flow control digits and may be used in networking to specify smaller pieces that a larger network layer packs is broken into. A flit may be associated with a specification of a data link frame (in the context of OpenCAPI architecture specification). The flit may be defined as a 64 byte unit of data.

For control template 240, a single slot may include 28 bits and 16 slots together comprise 56 bytes. Command template 240 (e.g., template 1A) may additionally provide an ability to send 40 data bytes from host computing device 110 to a memory DIMM 140 along with two 2-slot commands.

Xmeta bytes may provide capacity for RAIM error correction code (ECC) check bytes (8 bytes of ECC for 32 bytes of data). In some implementations, Reed-Solomon code may be used and may comprise 64 bytes of data and 16 ECC bytes. Data and ECC may be spread across 8 channels 135 so that there are 4 RAIM ECC blocks contained within 8 template 1A data transfers.

Other fields in slot 15 represent credit returns (TLX.vc0, TLX.vc3, TLX.dcp0), data valid indicators (V) and space for an additional command address bit for commands that provide a memory address (Cmd01_PA4,Cmd23_PA4); R bits are reserved. In some implementations, Cancel command template 235 may occupy one 2-slot position, other 2-slot position available for other 2 slots commands such as pr_rd_mem (read command or fetch) or pr_wr_mem (write command or store).

As shown in FIG. 2E, various actions 245 may be taken for the cancel command. The table in FIG. 2E describes what action may be taken when a cancel command targets a read command (e.g., pr_rd_mem). In some examples, the action may depend on where the read command currently resides in control flow stages of a memory buffer chip (e.g., memory buffer chip 150). The CAPPTag identifier, sent with the cancel command, may be used for detecting a match with any pending read command CAPPTags in the control flow stages. In some implementations, the order of rows in the table may represent a time sequence.

As shown in FIG. 2E, if the cancel command is at a new command first in first out (FIFO) stage (of the control flow stages), then the action may be to flag the cancel command for movement to drop response queue in a future stage. As shown in FIG. 2E, if the cancel command is at a reorder queue stage (pre-activate command to DRAM and activate up to read to DRAM), then the action may be to move the cancel command to drop response queue. As shown in FIG. 2E, if the cancel command is at a reorder queue stage (read to DRAM), then the action may be to flag the cancel command for movement to drop response queue in a future stage.

As shown in FIG. 2E, if the cancel command is at a data state machine/read dataflow stage, then the action may be to flag the cancel command for movement to drop response queue in a future stage. As shown in FIG. 2E, if the cancel command is at an OpenCAPI transaction layer transmission stage, then the action may be to move the cancel command to drop response queue. As shown in FIG. 2E, if the cancel command is at an OpenCAPI datalink layer stage (and beyond), then the action may be to send the read command with data obtained based on the read command. In other words, there may not be a drop response (also referred to cancel command response). In this regard, data may be obtained as a result of the read command being cancelled in an untimely manner. Based on the foregoing, host computing device 110 may receive a normal read response with data if the cancel command is untimely received by memory buffer chip 150 or host computing device 110 may receive a cancel command response (or drop response) if the cancel command is honored (e.g., successful processed by memory buffer chip 150).

As shown in FIG. 2F, and by reference number 250, memory controller 120 may receive a cancel command response via the unavailable channel. For example, memory buffer chip 150 may provide the cancel command response based on receiving the cancel command. Memory buffer chip 150 may provide the cancel command response (as shown by the arrow directed toward to memory controller 120) to indicate that the read command has been successfully cancelled and to indicate that no data will be obtained and returned as a result of the read command.

By not returning the data, the cancel command response (and the cancel command) may preserve bandwidth that would been used to provide data to host computing device 110. By not returning the data, the cancel command response may prevent data transfer, thereby freeing up resources that would have been used to perform the data transfer. The cancel command response may include information identifying the read command.

In some implementations, the cancel command response may be included in a template of OpenCAPI (e.g., a template of OpenCAPI transaction layer). In this regard, the information identifying the cancel command response may include a CAPPTag identifier identifying the read command. The cancel command response may be an out-of-spec drop response from DIMM 140-7 to host computing device 110 indicating that the read command has been successfully cancelled.

As shown in FIG. 2F, an example cancel command response 255 may be provided as a response to the cancel command. Cancel command response 255 may be included in an OMI transaction layer 3.1 control template (0xB). As shown in FIG. 2F, cancel command response 255 may include an opcode 00001111 indicating that the read command has been successfully cancelled. In some implementations, cancel command response 255 may be used to release CAPPtag identifiers (included in the read command) for reuse.

As shown in FIG. 2G, an example control template 260 may be used to send the cancel command response. The cancel command response may reside in either of the 1-slot positions #14 or 15. As shown in FIG. 2G, template 260 (e.g., template B or template 0xB) may be part of OpenCAPI Transaction Layer Specification 3.1. Control template 260 may support a 40 byte data payload spread across the data and xmeta fields. In some examples, the cancel command response may be data-less (e.g., not include data) but can may be combined with other responses that provide data (e.g., a read response). In some situations, the read response and associated data may not be included in the same template.

As shown in FIG. 2H, implementations may be applicable to a memory mirroring application. A memory mirroring application may include duplicating regions of memory in 2 DIMMs to prevent single points of failure. In some implementations, staggering of refresh operations may be applicable to the memory mirroring application for a performance advantage similar to a RAIM system.

In some examples, host computing device 110 may issue a read command and memory controller 120 may provide the read command (to read memory) to memory DIMM 140-0 and memory DIMM 140-1 to see which memory DIMM 140 responds first (e.g., to see which memory DIMM140 is first to provide a read response).

As shown in FIG. 2H, and by reference number 265, memory controller 120 may receive a read response via N−1 channels. For example, based on providing the read command, memory controller 120 may receive a read response in a manner similar to the manner described above in connection with FIG. 2B. Memory controller 120 may receive the read response via N−1 channels (as shown by the arrow directed toward to memory controller 120). In this example, as shown in FIG. 2H, memory controller 120 may receive the read response via one channel 135 (of the two channels 135) from memory DIMM 140-0.

As shown in FIG. 2H, no response may be received from memory DIMM 140-1 via another channel 135 (of the two channels 135). The other channel 135 may be referred to as an unavailable channel 135. Once the read response is received from one of the memory DIMMs, a cancel command can be sent to the other memory DIMM. As discussed in connection with FIG. 2F, either a drop response or a read response may be received from a memory DIMM 140 that received a cancel command based on the timing of cancel relative to availability of data from the memory DIMM 140.

As shown in FIG. 2I, and by reference number 270, memory controller 120 may send a cancel command. For example, based on receiving the read response for one channel 135, memory controller 120 may send the cancel command to the unavailable channel 135 (as shown in the arrow directed to the unavailable channel 135), in a manner similar to the manner discussed in connection with FIG. 2C.

In some examples, a cancel operation, to cancel a read response as described, may provide a method to remove pending operations on memory buffer for marked channel. In some implementations, unavailable channel 135 may be marked during runtime due to an error or for maintenance purposes. Operations requested by host may already be enqueued in a memory buffer chip. Marking unavailable channel 135 may cause host computing device 110 to ignore pending operations (e.g. read responses). Interface to memory channel remains active despite presence of channel mark.

In some implementations, unavailable channel 135 may be marked temporarily because, for example, a cause of an error is removed or maintenance operation is completed. Pending operations in memory buffer should be removed using a cancel operation to prevent aliasing to new commands issued by host computing device 110 once the unavailable channel is no longer marked (e.g., the mark has been removed).

As indicated above, FIGS. 2A-2I are provided as an example. Other examples may differ from what is described with regard to FIGS. 2A-2I. The number and arrangement of devices shown in FIG. 1 are provided as an example. A network, formed by the devices shown in FIGS. 2A-2I may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A-2I. Furthermore, two or more devices shown in FIGS. 2A-2I may be implemented within a single device, or a single device shown in FIGS. 2A-2I may be implemented as multiple, distributed devices. Additionally, or alternatively, a set of devices (e.g., one or more devices) shown in FIGS. 2A-2I may perform one or more functions described as being performed by another set of devices shown in FIGS. 2A-2I.

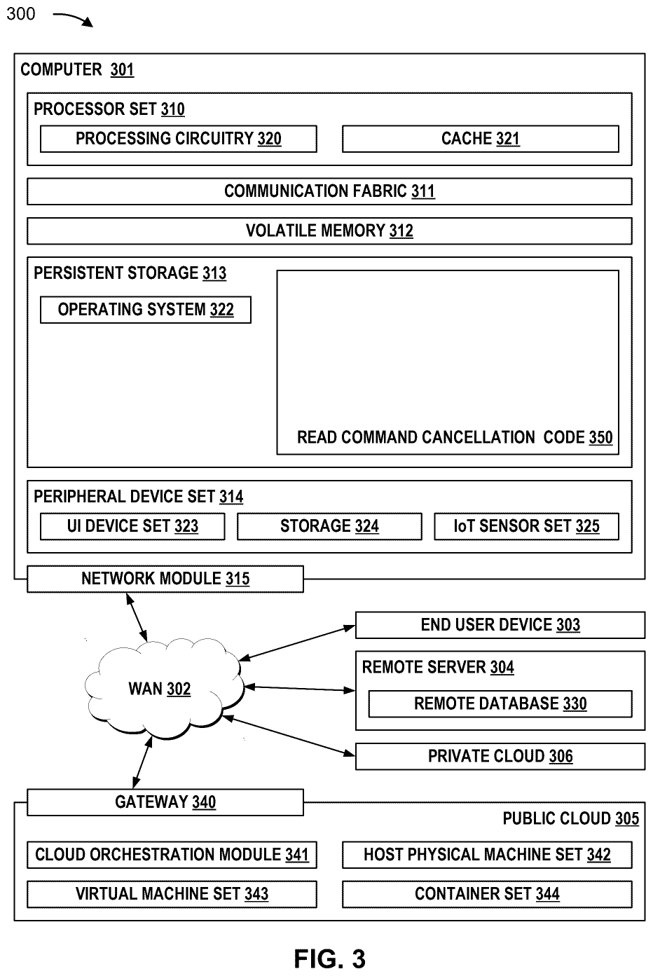

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as read command cancellation code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

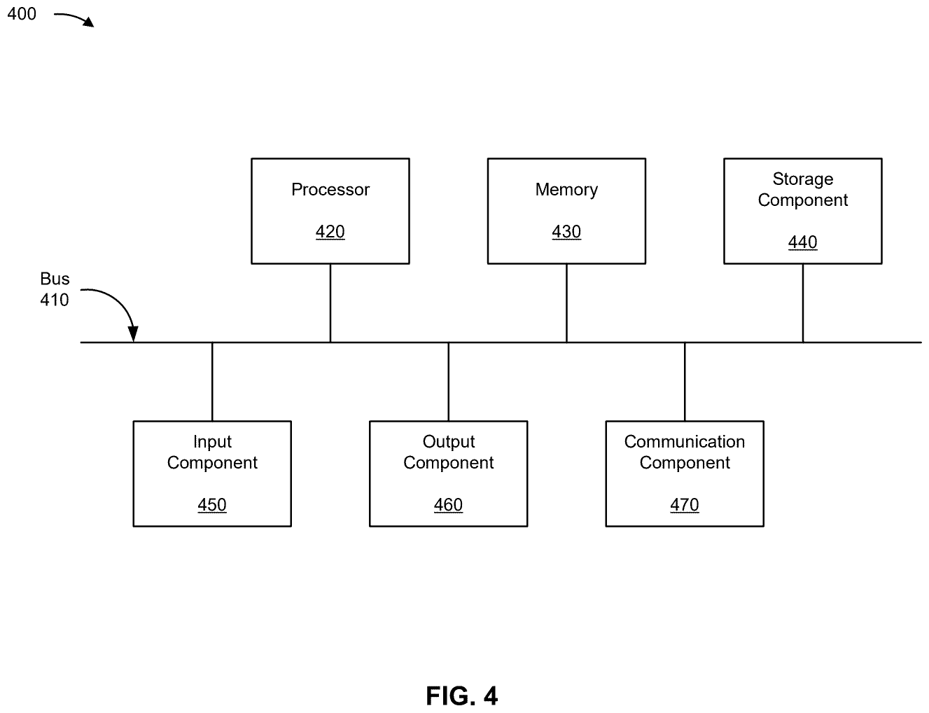

FIG. 4 is a diagram of example components of a device 400, which may correspond to host computing device 110. In some implementations, physical machine 105 may include one or more devices 300 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

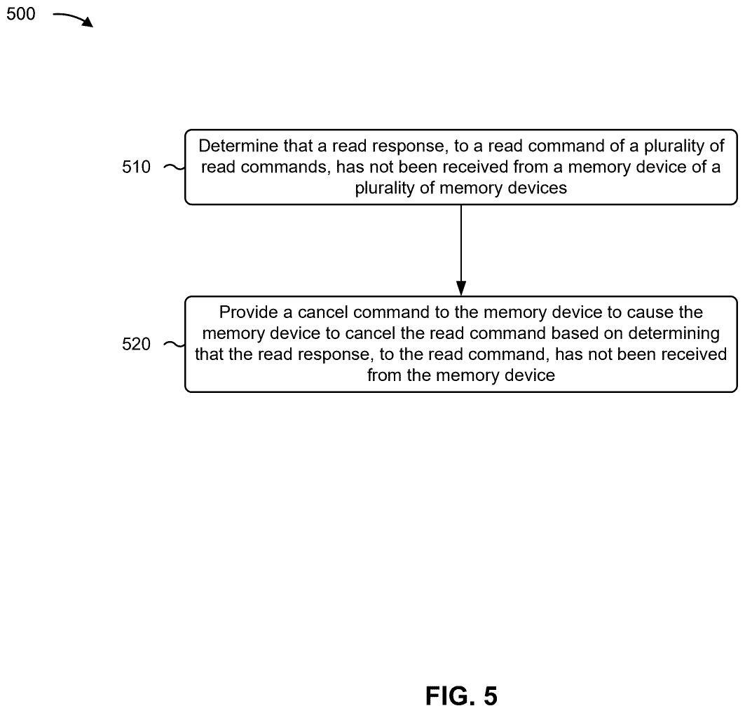

FIG. 5 is a flowchart of an example process 500 associated with cancelling read commands as described herein. In some implementations, one or more process blocks of FIG. 5 may be performed by a controller (e.g., memory controller 120). In some implementations, one or more process blocks of FIG. 5 may be performed by another device or a group of devices separate from or including the controller, such as one or more memory DIMMs 140, one or more memory DRAMs 145, and/or one or more memory buffer chips 150. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include determining that a read response, to a read command of a plurality of read commands, has not been received from a memory device of a plurality of memory devices (block 510). For example, the controller may determine that a read response, to a read command of a plurality of read commands, has not been received from a memory device of a plurality of memory devices, as described above.

As further shown in FIG. 5, process 500 may include providing a cancel command to the memory device to cause the memory device to cancel the read command based on determining that the read response, to the read command, has not been received from the memory device, wherein the cancel command is provided after read responses, to other read commands of the plurality of read commands, have been received from other memory devices of the plurality memory devices, and wherein the cancel command includes an identifier associated with the read command (block 520). For example, the controller may provide a cancel command to the memory device to cause the memory device to cancel the read command based on determining that the read response, to the read command, has not been received from the memory device, wherein the cancel command is provided after read responses, to other read commands of the plurality of read commands, have been received from other memory devices of the plurality memory devices, and wherein the cancel command includes an identifier associated with the read command, as described above. In some implementations, the cancel command is provided after read responses, to other read commands of the plurality of read commands, have been received from other memory devices of the plurality memory devices. In some implementations, the cancel command includes an identifier associated with the read command. The cancel command may be provided to the memory device based on the memory device being delayed due to a memory refresh operation. The memory device may not provide the read response based on the memory device being delayed due to the memory refresh operation.

In some implementations, process 500 includes receiving the read responses, from the memory devices, via a portion of a plurality of channels, wherein the plurality of memory devices are included in a redundant array of independent memory (RAIM) system that includes the plurality of channels and a RAIM, and wherein the plurality of memory devices are connected to a redundant array of independent memory (RAIM) via the plurality of channels, and providing data, included in the read responses, to the RAIM without receiving the read response, to the read command, from the memory device.

In some implementations, process 500 includes providing a cancel command to the memory device based on providing the data, included in the read responses, to the RAIM without receiving the read response, to the read command, from the memory device.

In some implementations, the read response is to be received from a channel of the plurality of channels, and wherein the method further comprises marking the channel as unavailable based on the read response, to the read command, not being received prior to providing the data to the RAIM, and marking the channel as available, after marking the channel as unavailable, to enable new operations to be provided by the controller via the channel.

In some implementations, the plurality of channels are N channels, and wherein receiving the read responses comprises receiving the read responses, from the memory devices, via N−1 channels.

In some implementations, the read response is not received from a channel of the plurality of channels, and wherein, to provide the cancel command, the controller is to provide the cancel command for read commands provided via the channel.

In some implementations, process 500 includes receiving information indicating that the read command has been cancelled.

In some implementations, the plurality of memory devices include two memory devices in a memory mirroring system, and wherein, to provide the cancel command, the controller is to receive a read response from a first memory device of the two memory devices, and providing the cancel command to a second memory device subsequent to receiving the read response from the first memory device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system comprising:
a plurality of memory devices; and
a memory controller, in communication with the plurality of memory devices, to:
provide a plurality of read commands to the plurality of memory devices;
determine that a read response, to a read command of the plurality of read commands, has not been received from a memory of the plurality of memory devices; and
provide a cancel command to the memory device to cause the memory device to cancel the read command based on determining that the read response, to the read command, has not been received from the memory device,
wherein the cancel command includes an identifier associated with the read command, and
wherein the memory device identifies the read command using the identifier.

2. The system of claim 1, wherein the memory controller is to:
receive information indicating that the read command has been cancelled.

3. The system of claim 1, further comprising:
a redundant array of independent memory (RAIM) decoder; and
a plurality of channels,
wherein the plurality of memory devices are connected to the RAIM decoder via the plurality of channels.

4. The system of claim 3, wherein the controller is to:
receive read responses, from a portion of the plurality of memory devices, to a portion of the plurality of read commands via a portion of the plurality of channels,
wherein the read responses include data; and
provide the data to the RAIM without receiving the read response, to the read command, from the memory device.

5. The system of claim 4, wherein the controller is to:
provide the cancel command to the memory device based on providing the data, included in the read responses, to the RAIM decoder without receiving the read response, to the read command, from the memory device.

6. The system of claim 4, wherein the read response is to be received from a channel of the plurality of channels, and
wherein the controller is to:
mark the channel as unavailable based on the read response, to the read command, not being received prior to providing the data to the RAIM decoder; and
mark the channel as available, after marking the channel as unavailable, to enable new operations to be provided by the controller via the channel.

7. The system of claim 4, wherein the read response is not received from a channel of the plurality of channels, and
wherein, to provide the cancel command, the controller is to:
provide the cancel command for read commands provided via the channel.

8. The system of claim 4, wherein the plurality of memory devices include two memory devices in a memory mirroring system, and
wherein, to provide the cancel command, the controller is to:
receive a read response from a first memory device of the two memory devices; and
provide the cancel command to a second memory device subsequent to receiving the read response from the first memory device.

9. A computer-implemented method, comprising:
determining, by a controller, that a read response, to a read command of a plurality of read commands, has not been received from a memory device of a plurality of memory devices; and
providing, by the controller, a cancel command to the memory device to cause the memory device to cancel the read command based on determining that the read response, to the read command, has not been received from the memory device,
wherein the cancel command is provided after read responses, to other read commands of the plurality of read commands, have been received from other memory devices of the plurality of memory devices, and
wherein the cancel command includes an identifier associated with the read command.

10. The computer-implemented method of claim 9, comprising:
receiving the read responses, from the memory devices, via a portion of a plurality of channels,
wherein the plurality of memory devices are included in a redundant array of independent memory (RAIM) system that includes the plurality of channels and a RAIM decoder, and
wherein the plurality of memory devices are connected to the RAIM decoder via the plurality of channels; and
providing data, included in the read responses, to the RAIM decoder without receiving the read response, to the read command, from the memory device.

11. The computer-implemented method of claim 10, comprising:
providing a cancel command to the memory device based on providing the data, included in the read responses, to the RAIM decoder without receiving the read response, to the read command, from the memory device,
wherein the cancel command is provided to the memory device based on the memory device being delayed due to a memory refresh.

12. The computer-implemented method of claim 11, wherein the read response is to be received from a channel of the plurality of channels, and
wherein the method further comprises:
marking the channel as unavailable based on the read response, to the read command, not being received prior to providing the data to the RAIM decoder; and
marking the channel as available, after marking the channel as unavailable, to enable new operations to be provided by the controller via the channel.

13. The computer-implemented method of claim 10, wherein the plurality of channels are N channels, and
wherein receiving the read responses comprises:
receiving the read responses, from the memory devices, via N−1 channels.

14. The computer-implemented method of claim 10, wherein the read response is not received from a channel of the plurality of channels, and
wherein, to provide the cancel command, the controller is to:
providing the cancel command for read commands provided via the channel.

15. The computer-implemented method of claim 9, comprising:
receiving information indicating that the read command has been cancelled.

16. The computer-implemented method of claim 9, wherein the plurality of memory devices include two memory devices in a memory mirroring system, and
wherein, to provide the cancel command, the controller is to:
receiving a read response from a first memory device of the two memory devices; and
providing the cancel command to a second memory device subsequent to receiving the read response from the first memory device.

17. A computer program product comprising:
one or more computer readable storage media, and program instructions collectively stored on the one or more computer readable storage media, the program instructions comprising:
program instructions to determine that a read response, to a read command of a plurality of read commands, has not been received from a memory device of a plurality of memory devices; and
program instructions to provide a cancel command to the memory device to cause the memory device to cancel the read command based on determining that the read response, to the read command, has not been received from the memory device,
wherein the cancel command is provided after read responses, to other read commands of the plurality of read commands, have been received from other memory devices of the plurality memory devices.

18. The computer program product of claim 17, wherein the read response is expected to be received via a channel of the plurality of channels, and
wherein the program instructions further comprise:
program instructions to receive the read responses via other channels of the plurality of channels,
wherein the read responses include data; and
program instructions to provide the data to the RAIM decoder without receiving the read response, to the read command, from the memory device.

19. The computer program product of claim 17, wherein the program instructions to provide the cancel command comprise:
program instructions to provide the cancel command via a channel,
wherein the cancel command includes an identifier associated with the read command, and
wherein the program instructions further comprise:
program instructions to receive information indicating that the read command has been cancelled,
wherein the information is received via the channel.

20. The computer program product of claim 17, wherein the program instructions further comprise:
program instructions to mark the channel as unavailable to cause operations performed via the channel to be ignored,
wherein the operations include additional read responses.
